(19) United States
(12) Patent Application Publication
(10) Pub. No.: US 2009/0001638 A1
(43) Pub. Date: Jan. 1, 2009

(54) BELLOWS STRUCTURE

(76) Inventors: Gilbert A. Semaan, South Bend, IN (US); Darron G. Peddle, Millersburg, IN (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/044,201

(22) Filed: Mar. 7, 2008

Related U.S. Application Data
(60) Provisional application No. 60/946,759, filed on Jun. 28, 2007.

(51) Int. Cl. F16F 5/00; B29C 41/00

(52) U.S. Cl. 267/122; 137/594; 264/299

(57) ABSTRACT

A bellows structure (10) comprises a first end (50), a second end (52), and a wall (54) extending axially therebetween. The wall (54) includes a plurality of lobe portions (80) and furrow portions (82) connecting adjacent lobe portions (80). The furrow portions (82) are radially recessed relative to the lobe portions (80) when the bellows wall (54) is in an unstressed state. To increase the volume of the bellows chamber (56) in response to fluid condition changes, the furrow portions (82) unfold and move radially outward.

### RELATED APPLICATION

This application claims priority under 35 U.S.C. §119(e) to U.S. Provisional Patent Application No. 60/946,759, filed on Jun. 28, 2007. The entire disclosure of this provisional application is hereby incorporated by reference.

### FIELD

A bellows structure having a wall that expands and contracts in response to changes in fluid conditions.

### BACKGROUND

A bellows structure can be used in a fluid system to compensate for changes in relative fluid conditions (e.g., pressure, temperature, volume). A bellows structure can comprise a first end, a second end, and an elastically-behaving wall extending axially therebetween. The bellows wall defines an interior chamber that communicates with one fluid (i.e., an interior fluid) and the wall's exterior is surrounded by another fluid (i.e., an exterior fluid). During the operation of the fluid system, the bellows wall expands and contracts in response to changes in the conditions of the interior fluid and/or changes in the conditions of the exterior fluid.

### SUMMARY

A bellows structure comprises a wall having lobe portion(s) and furrow portion(s). In an unstressed (and/or contracted) state, each furrow portion is folded radially inward and recessed relative to its neighboring lobe portions. To increase the volume of the bellows chamber in response to fluid conditions, the furrow portion unfolds by moving radially outward.

With the bellows structure, the exterior fluid can occupy the void(s) between the lobe portions when the wall is in a contracted state. Thus, bellows structure does not require a radial orbit therearound to allow radial expansion. Also, because the wall does not axially expand, the bellows structure does not require extra extension space to accommodate an elongated expanded shape. The bellows structure can be constructed to snugly fit within a slender host tube, its radial/axial dimensions can be decreased, and/or material costs can be reduced.

The bellows wall transmutes between and among a contracted shape and an expanded shape by folding and unfolding of the furrow portions. The wall material need not be subjected to the repeated stretch-release cycles and the associated stress, strain, and/or wall-thinning tension. In contrast, with a cylindrical bellows wall, for example, the wall material must stretch to achieve radial expansion.

The bellows wall can be constructed without undercuts whereby it can be efficiently and economically manufactured. Specifically, for example, the mold core can be removed from the bellows wall while it is still in its original molded shape. Core-stripping does not require air-pumping, tugging, or stretching of the just-molded wall material so that undercuts can clear core contours. And if a single-cavity mold is used, the bellows wall will not have a parting line. With an axially-expanding accordion bellows wall, for example, core-stripping can be major obstacle in the manufacturing process (and a two-part mold cavity is usually a must).

These and other features of the bellows structure are fully described and particularly pointed out in the claims. The following description and annexed drawings set forth in detail certain illustrative embodiments, these embodiments being indicative of but a few of the various ways in which the principles may be employed.

### DRAWINGS

FIG. 1 is a schematic diagram of the bellow structure and its interaction with an interior fluid and an exterior fluid.

FIG. 2 is an isolated perspective view of the bellow structure.

FIG. 3 is a side view, partially in section, of a fluid system incorporating the bellows structure.

FIGS. 4A-4D are front and sectional views of one possible form of the bellows wall. The bellows wall is shown in an unstressed state in FIGS. 4A-4C and is shown in an expanded state in FIG. 4D.

FIGS. 5A-5E are bottom, side and sectional views of another possible form of the bellow wall. The bellows wall is shown in an unstressed state in FIGS. 5A-5D and is shown in an expanded state in FIG. 5E.

FIGS. 6A-6C are each a cross-sectional view of other possible forms of the bellow wall in an unstressed state.

FIGS. 7A-7E are schematic views of the steps of a split-cavity molding process for making the bellows wall.

FIGS. 8A-8E are schematic views of the steps of a single-part cavity molding process for making the bellows wall.

### DESCRIPTION

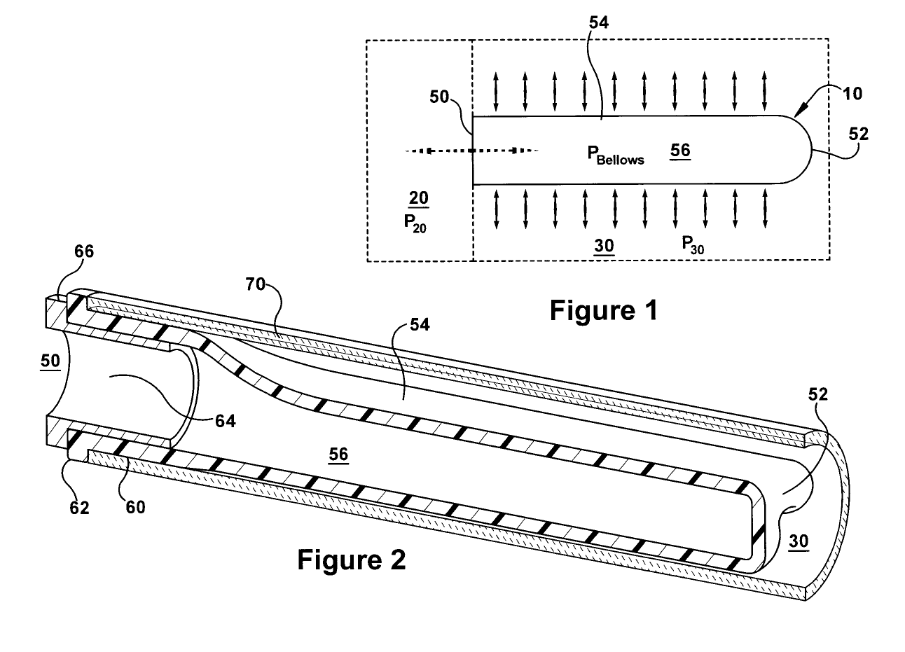

Referring now to the drawings, and initially to FIG. 1, the bellows structure 10, and its interaction with fluids 20 and 30, are schematically shown. The bellows structure 10 comprises a first end 50, a second end 52, and a wall 54 extending axially therebetween. The wall 54 defines an interior chamber 56 that communicates (and will usually contain) with the fluid 20 and the wall's exterior is surrounded by the fluid 30.

The fluid 20 can conveniently be called the “interior fluid” and the fluid 30 can conveniently be called the “exterior fluid” in accord with their relation to the bellows structure 10. The interior fluid 20 or the exterior fluid 30 (but usually not both) can simply be that of the environment in which the bellows structure 10 is placed. For example, the fluid 20/30 could comprise ambient air. Additionally or alternatively, one or both of the fluids 20 and 30 can be sealed within a fixed volume of space. In some applications, such as, for example, those involving instrumentation readings, the interior fluid 20 can be contained in a very small space (or even none at all) outside the bellow chamber 56.

In the illustrated bellows structure 10, the first end 50 is an open end (through which the interior fluid 20 passes into the chamber 56) and the second end 52 is a closed end. A bellows structure 10 with two open ends or a bellows structure with two closed ends are possible and contemplated. For example, the bellows structure 10 could have both ends open to compensate for volumetric changes of a fluid during its passage through the bellows chamber 56. Or the bellows structure 10 could have both ends closed and another fluid entry path into the bellows chamber 56. In either or any event, the bellows chamber 56 is sealed or otherwise isolated from the exterior fluid 30.

The bellows wall 54 is elastically-behaving in that it will bias back to an original unstressed state when the relevant expansion forces are removed. The wall material can be, for example, a thermoset polymer, such as natural rubber and/or synthetic rubber (e.g., bisphenol cured FKM rubber or peroxide cured EPDM rubber). The wall 54 can be molded in one piece from this elastomeric material.

During operation of this fluid system, the portions of the bellows wall 54 (i.e., bellow portions 82 introduced below) radially move to compensate for changes in relative fluid conditions (e.g., pressure, temperature, volume). In some cases, the conditions of one fluid (i.e., either the interior fluid 20 or the exterior fluid 30) are expected to remain substantially constant and the conditions of the other fluid are expected to fluctuate during operation. In other cases, the conditions of both fluids 20 and 30 are expected to vacillate.

When the wall 54 is in an unstressed state, it is in a preset unbiased shape and no resilient forces are at work trying to return it to another shape. Prior to installation and/or initiation of the bellows structure 10 into a fluid system, the wall 54 will be in this unstressed state. During operation of the fluid system, the bellows wall 54 can be in the unstressed state when the pressure P_{bellows} within the chamber 56 is approximately the same as the pressure P₃₀ of the exterior fluid. (The chamber pressure P_{bellows} will usually be approximately equal to the pressure P₂₀ of the interior fluid 20.)

If the bellows pressure P_{bellows} increases and/or the exterior pressure p₃₀ decreases, the wall 54 will radially expand to compensate. This radial expansion increases the volume of the bellows chamber 56 and, in some cases, decreases the volume of space occupied by the exterior fluid 30. The chamber volume can increase, and continue to increase, until its pressure P_{bellows} corresponds to an exterior pressure Pₑₓₜₑᵣᵢₒᵣ. The bellows structure 10 can be designed so that it has an expanded state (i.e., a maximum expansion shape) that can accommodate the expected range of fluid conditions.

Referring now to FIG. 2, the bellows wall 54 can comprise a stem portion 60 at its open end 50 and this stem 60 can include a flanged rim 62. The bellows structure 10 can further comprise a cap 64 (also having a flanged rim 66) positioned within the stem 60. The open end 50 and/or the stem portion 60 often are the mounting area for the bellows structure 10, and the wall 54 cantilevers therefrom. The cap 64 can be made of relatively rigid material (e.g., plastic) to reinforce this mounting area. The cap's rim 66 can additionally or alternatively coordinate with the stem's rim 62 when sealing the bellows wall 54 from the exterior fluid 30.

The bellows wall 54 can have a slender profile with its axial length being at least four times, at least ten times, and/or at least fifteen times its outer diameter. The wall 54 can have an axial length of between about 50 mm and 200 mm and/or an outer diameter between about 4 mm and 20 mm. Except for the stem portion 60, the wall 54 can have the same thickness throughout its axial length (and in its closed end 52). This thickness can be, for example, in the range of about 1 mm (e.g., from about ½ mm to about 2 mm). A thickened stem portion 60 can have a thickness in the range of about 2 mm (e.g., from about 1 mm to about 3 mm).

The bellows structure 10 can further comprise a host tube 70 (e.g., a glass tube) containing the exterior fluid 30. The wall 54 is inserted into and surrounded by this tube 70 . The host tube 70 need not provide a radial orbit around the bellows wall 54 (in its unstressed and/or contracted state) and need not be axially longer than the bellows wall 54. Thus, the bellows structure 10 can be constructed to fit snugly within a slender host tube 70.

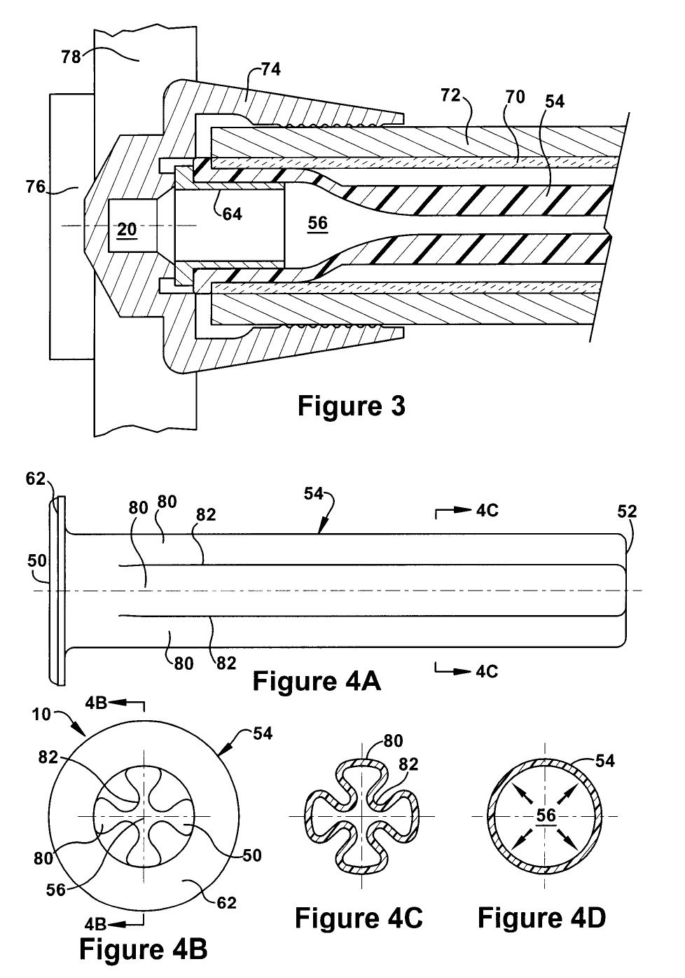

As shown in FIG. 3, the host tube 70 can be further surrounded by another conduit 72. A fitting 74 (e.g., a threaded fitting) can be used to close the conduit 72 and connect the bellows chamber 56 to the interior fluid 20. Instrumentation 76 can be associated with the bellows structure 10 and a harness 78 can be used to convey electrical signal lines to a remote controller.

Referring now to FIGS. 4A-4D, the wall 54 is shown isolated from the rest of the bellows structure 10. The bellows wall 54 comprises a plurality of lobe portions 80 and furrow portions 82 connecting adjacent lobe portions 80. When the wall 54 is in the unstressed state, it has an unstressed shape whereat the lobe portions 80 outline the wall's outer diameter (OD). And the furrow portions 82 are folded radially inward and recessed relative to the lobe portions 80. (FIGS. 4A-4C.)

If the bellows structure 10 has a host tube 70 (see e.g., FIGS. 2 and 3), the tube's inner diameter can correspond to wall's the outer diameter in its unstressed shape. For example, it can be sized to hug the crowns of the lobe portions 80, with the exterior fluid 30 occupying the voids therebetween. If the host tube 70 is rigid, it also can set the limits on, and/or define, the expanded shape of the bellows wall 54 in its expanded state.

During operation of the fluid system, the furrow portions 82 unfold by moving radially outward to increase the volume of the bellows chamber 56. The lobe portions 80 can remain radially stable (or they can expand only slightly radially outward), as the wall 54 transmutes to a substantially cylindrical expanded shape.

(FIG. 4D.) A cylindrical host tube 70 (that snugly surrounds the crowns of the lobe portions 80) is compatible with this expansion geometry.

The wall's outer diameter (OD) in this expanded shape will be substantially the same as that in its contracted shape. The bellows wall 54 transmutes between shapes without stretching or thinning of the wall material. For example, the furrow portions 82 are substantially the same thickness in both the contracted shape and the expanded shape. (Compare FIGS. 4C and 4D.) Thus, the wall material need not be subjected to the repeated stretch-release cycles and the associated stress, strain, and/or wall-thinning tension.

The bellows structure 10 shown in FIGS. 4A-4D has four lobe portions 80 (and thus four furrow portions 82) and resembles a four-leaf clover. The lobe portions 80 are substantially the same size and shape, have centerlines that commonly intersect, and are symmetrical about each quadrant. The furrow portions 82 are pushed in four directions (e.g., 90° part) to expand them radially outward. (See arrows in FIG. 4D.)

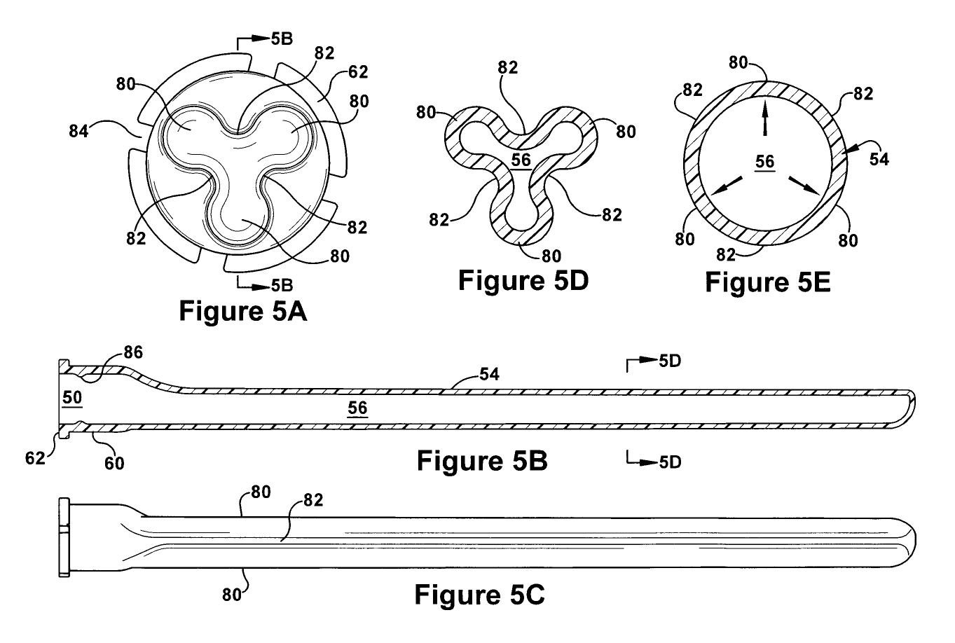

The bellows structure 10 shown in FIGS. 5A-5E has three lobe portions 80 (and thus three furrow portions 82) and resembles a three-leaf clover. The lobe portions 80 are substantially the same size and shape, and have centerlines that commonly intersect (but they are not symmetrical). The furrow portions 82 are pushed in three directions (e.g., 120° part) to expand them radially outward. (See arrows in FIG. 5E.) These figures also show that the stem's rim 62 can have slots 84 (FIG. 5A) and/or that the stem portion 60 itself can have notches 86 (FIG. 5B) for engagement with the top cap hat 64, the host tube 70, or other relevant components.

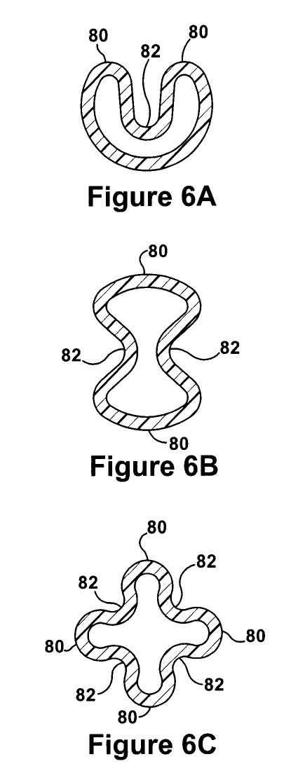

As shown in FIGS. 6A-6C, the bellows wall 54 can have other lobe-furrow shapes. For example, the wall 54 can have a two-lobe construction with one furrow portion 82 (FIG. 6A) or two furrow portions 82 (FIG. 6B). And the convexity and/or concavity of the portions 80/82 can be selected to provide the desired bellows characteristics. For example, a four-lobe wall 54 can be constructed to resemble a rounded-end-cross, rather than a four-leaf clover (FIG. 6C). A range of bellows wall constructions are possible with at least one lobe portion 80 and at least one furrow portion that unfolds by moving radially outward to increase the chamber's volume.

In the bellows structure 10, the lobe portions 80 can extend along a substantial distance of the wall's axial length, such as from the closed end 52 to the stem portion 60. The lobe radial geometry can be dimensioned so as to not undulate along their axial extent in the unstressed state. If so, the bellows wall 54 can be characterized by an absence of undercuts. Additionally or alternatively, the lobe radial dimensions can not increase towards a closed end (e.g., the closed end 52) and/or they can remain substantially the same along the axial extent of the lobe portions 80.

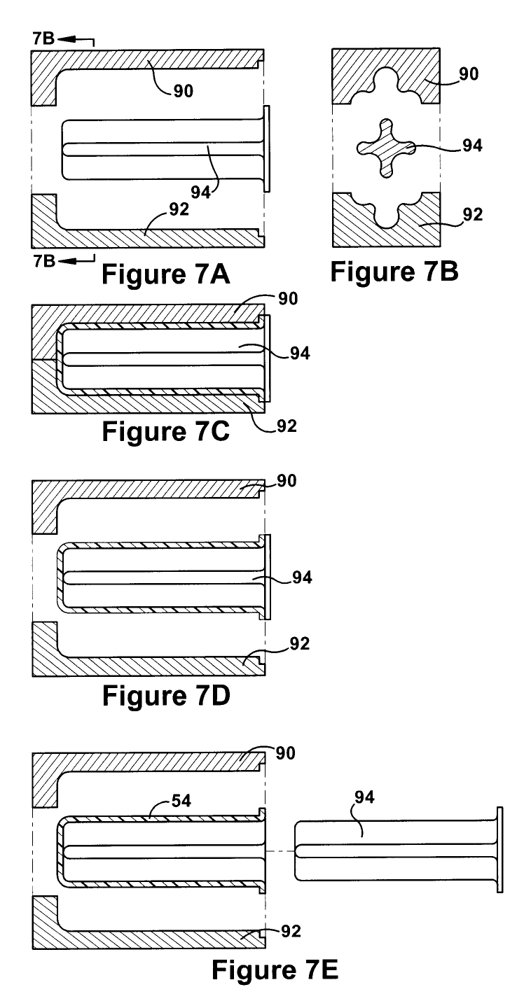

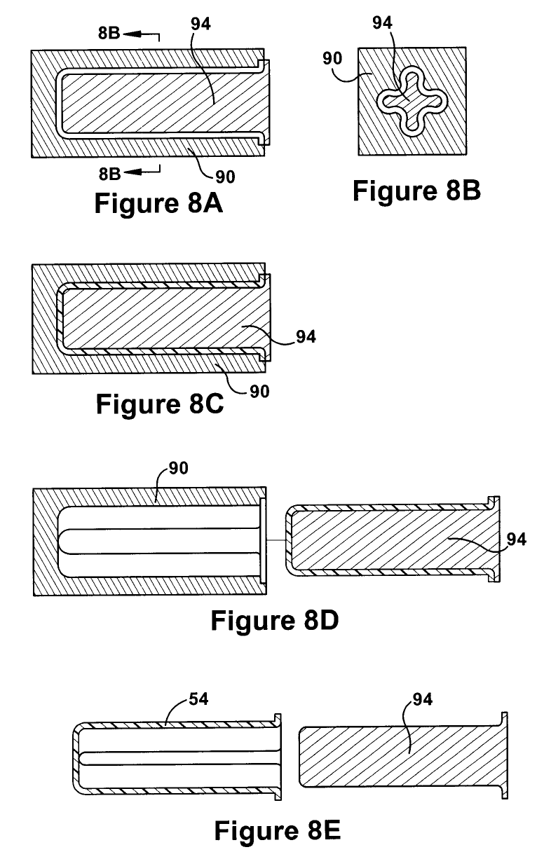

The lobe geometry facilitates the molding of the bellows wall 54. As shown schematically in FIGS. 7A-7E, this molding can involve a split mold cavity (with mold parts 90 and 92) and a mold core 94. The wall 54 is molded around the core 94 (which mirrors the clover shape of the bellows chamber 56) and then the core 94 is removed while the wall 54 is in an unstressed state. Moreover, as shown schematically in FIGS. 8A-8E, the bellows wall 54 can be molded in a single cavity mold 90, thereby eliminating a parting line 96 thereon.

One may now appreciate that the bellows structure 10 can be slenderly constructed, optimizes space requirements, avoids stretching stresses, facilitates core-stripping in a molding process, and/or erases a parting line from the manufacturing equation.

Although the bellows structure, the bellows wall, the host tube, the fluid system, related elements and components and/or corresponding methods have been shown and described with respect to a certain embodiment or embodiments, it is obvious that equivalent alterations and modifications will occur to others skilled in the art upon the reading and understanding of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application. If incorporated-by-reference subject matter is inconsistent with subject matter expressly set forth in the written specification (and/or drawings) of the present disclosure, the latter governs to the extent necessary to eliminate indefiniteness and/or clarity-lacking issues.

1. A bellows structure comprising a first end, a second end, and a wall extending axially therebetween which defines an interior chamber;
the wall transmuting between and among a contracted shape and an expanded shape to change the chamber's volume in response to condition changes in an interior fluid within the volume and/or in an exterior fluid surrounding the wall;
the wall having at least one lobe portion, and at least one furrow portion that unfolds by moving radially outward to increase the chamber's volume;
each furrow portion being folded radially inward and radially recessed relative to the lobe portion(s) when the wall is in an unstressed state.

2. A bellows structure as set forth in claim 1, wherein the wall comprises at least two lobe portions and a furrow portion connecting the two lobe portions.

3. A bellows structure as set forth in claim 2, wherein the wall comprises a furrow portion between adjacent pair of lobe portions.

4. A bellows structure as set forth in claim 2, wherein the crowns of the lobe portion at least partially outline the wall's outer diameter in the contracted shape and in the expanded shape.

5. A bellows structure as set forth in claim 4, wherein the wall's outer diameter is substantially the same in its contracted shape and expanded shape.

6. A bellows structure as set forth in claim 5, wherein the wall's expanded shape is substantially cylindrical.

7. A bellows structure as set forth in claim 2, further comprising a host tube in which the wall is inserted, wherein the inner diameter of the host tube hugs the lobe portions when the wall is in its contracted shape.

8. A bellows structure as set forth in claim 2, wherein the radial dimensions of the lobe portions do not undulate along their axial extent in an unstressed state whereby the wall can be characterized by an absence of undercuts.

9. A bellows structure as set forth in claim 2, wherein the first end and/or the second end is open for passage of the interior fluid in the bellow's chamber.

10. A bellows structure as set forth in claim 2, wherein, when the wall is in the unstressed state, each lobe portion has an axial extent and the radial dimensions of each lobe portion do not increase towards a closed end along this axial extent.

11. A bellows structure as set forth in claim 2, wherein, when the wall is in the unstressed state, each lobe portion has an axial extent and the radial dimensions of each lobe portion are substantially the same along this axial extent.

12. A bellows structure as set forth in claim 11, wherein the wall is molded in one piece from an elastomeric material.

13. A bellows structure as set forth in claim 11, characterized by the absence of a parting line on the wall.

14. A bellows structure as set forth in claim 2, wherein the wall is molded in one piece from an elastomeric material.

15. A bellows structure as set forth in claim 14, characterized by the absence of a parting line on the wall.

16. A bellows structure as set forth in claim 2, wherein the wall has substantially the same thickness throughout its non-stem portions.

17. A bellows structure as set forth in claim 2, wherein the lobe portion(s) and the furrow portion(s) each has a thickness when the wall is its contracted shape and each has substantially the same thickness when the wall is in its expanded state.

18. A bellows structure as set forth in claim 2, comprising at least three lobe portions.

19. A bellows structure as set forth in claim 2, comprising at least four lobe portions.

20. A fluid system comprising an interior fluid, an exterior fluid, and the bellows structure set forth in claim 1, the interior fluid communicating with the interior chamber of the bellows structure and the exterior fluid surrounding the axial wall.

21. A method of making the bellows structure set forth in claim 1, said method comprising the steps of:
molding the axial wall around a core;
removing the core from the molded axial wall while in an unstressed state.
